(19) United States
(12) Patent Application Publication
(10) Pub. No.: US 2020/0349071 A1
(43) Pub. Date: Nov. 5, 2020

(54) DATA STORAGE DEVICE, A CONTROLLER THEREFOR, AND AN OPERATION METHOD THEREOF

(71) Applicant: SK hynix Inc., Gyeonggi-do (KR)

(72) Inventor: Eu Joon BYUN, Gyeonggi-do (KR)

(21) Appl. No.: 16/700,828

(22) Filed: Dec. 2, 2019

(30) Foreign Application Priority Data
May 2, 2019 (KR) 10-2019-0051459

(51) Int. Cl. G06F 12/06; G06F 12/02; G06F 12/0882; G06F 11/30; G06F 11/10

(52) U.S. Cl. CPC G06F 12/0646; G06F 12/0246; G06F 12/0882; G06F 2212/7211; G06F 11/3037; G06F 11/1012; G06F 11/1044; G06F 12/0253

(57) ABSTRACT

A data storage device may include a storage including a nonvolatile memory apparatus, and a controller configured to communicate with the storage, to collect physical configuration information on the storage to divide the storage into a first area and a second area in response to a space division request of a host, and to provide the physical configuration information on the first area to the host, thereby giving internal operation management authority for the first area to the host.

### CROSS-REFERENCES TO RELATED APPLICATION

The present application claims priority under 35 U.S.C. § 119(a) to Korean application number 10-2019-0051459, filed on May 2, 2019, in the Korean Intellectual Property Office, which is incorporated herein by reference in its entirety.

### BACKGROUND

### 1. Technical Field

Various embodiments generally relate to a semiconductor integrated apparatus, and more particularly, to a data storage device, a controller therefor, and an operation method of the data storage device.

### 2. Related Art

A storage device is electrically connected to a host and performs a data input/output operation according to a request of the host. The storage device may use any of various storage media to store data.

An example of a data storage medium used by a storage device is a flash memory. With increased storage capacity and improved cost competitiveness due to technology development of the flash memory, a storage device using a flash memory is adopted even by data centers that handle large capacity data, as well as in personal computers (PCs) and mobile devices.

A flash memory is not able to be overwritten or in-place updated and has different read/write units and erase units. Moreover, a flash memory has a limited program/erase cycle.

Due to such flash memory characteristics, a separate file management technique for accessing or controlling the flash memory apparatus is required.

### SUMMARY

In an embodiment, a data storage device may include: a storage including a nonvolatile memory apparatus; and a controller configured to communicate with the storage, wherein the controller is configured to collect physical configuration information on the storage, divide the storage into a first area and a second area in response to a space division request from a host, and provide the physical configuration information on the first area to the host, thereby giving control of an internal operation for the first area to the host.

In an embodiment, a controller, which controls a storage including a nonvolatile memory apparatus, may include a space division circuit configured to collect physical configuration information on the storage, divide the storage into a first area and a second area in response to a space division request from a host, and provide the physical configuration information on the first area to the host, thereby giving control of an internal operation for the first area to the host.

In an embodiment, an operation method of a data storage device, which includes a storage including a nonvolatile memory apparatus and a controller configured to communicate with the storage, the operation method comprising: collecting, by the controller, physical configuration information on the storage in response to a space division request received from a host; dividing, by the controller, the storage into a first area and a second area based on the collected physical configuration information; and providing, by the controller, the physical configuration information on the first area to the host, thereby giving control for an internal operation performed in the first area to the host.

In an embodiment, a memory system may include: a non-volatile storage including a plurality of memory blocks; and a controller configured to divide the plurality of memory blocks into a plurality of areas, each including a respective subset of the plurality of memory blocks, in response to a request received from an external device and grant control of at least one of the plurality of areas to the external device.

### BRIEF DESCRIPTION OF THE DRAWINGS

FIG. 1 is a diagram of an electronic apparatus in accordance with an embodiment.

FIG. 2 is a diagram of a data storage device in accordance with an embodiment.

FIG. 3 is a diagram of a storage in accordance with an embodiment.

FIG. 4 is a diagram for explaining a management concept of the storage in accordance with an embodiment.

FIG. 5 is a diagram for explaining a space division concept of the storage in accordance with an embodiment.

FIG. 6 is a diagram for explaining a data management structure in accordance with an embodiment.

FIG. 7 and FIG. 8 are flowcharts for explaining an operation method of the data storage device in accordance with an embodiment.

FIG. 9 is a diagram illustrating a data storage system in accordance with an embodiment.

FIG. 10 and FIG. 11 are diagrams illustrating a data processing system in accordance with an embodiment.

FIG. 12 is a diagram illustrating a network system including a data storage device in accordance with an embodiment.

FIG. 13 is a block diagram illustrating a nonvolatile memory device included in a data storage device in accordance with an embodiment.

### DETAILED DESCRIPTION

A data storage device, a controller therefor, and an operation method of the data storage device are described in more detail with reference to the accompanying drawings. Throughout the specification, reference to “an embodiment,” “another embodiment” or the like is not necessarily to only one embodiment, and different references to any such phrase are not necessarily to the same embodiment(s). Also, the phrase “at least one of” used in conjunction with a list of elements or operations, e.g., A, B and C, means only A, only B, only C, only A and B, only A and C, only B and C, or A, B and C.

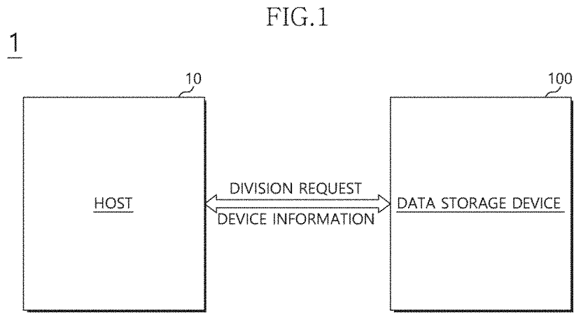

FIG. 1 is a diagram of an electronic apparatus 1 in accordance with an embodiment.

Referring to FIG. 1, the electronic apparatus 1 may include a host 10 and a data storage device 100.

The host 10 may transmit requests, addresses and/or data, related to data processing, to the data storage device 100. Data processing may include conversion of data into a usable and/or desired form. For example, data processing may include any of generating, updating, storing or erasing data. The data storage device 100 may perform operations corresponding to the requests and the addresses of the host 10. The data storage device 100 may transmit data to the host 10, in response to a host request.

The data storage device 100 may include a nonvolatile memory apparatus (NVM) as a storage. The data storage device 100 may also include a plurality of dies Die 0 to Die n, a plurality of chips, or a plurality of packages. In an embodiment, the data storage device 100 may use an indicator or an identifier (e.g., a flag) to show whether the storage supports space division. Physical locations in a space-division storage can be logically divided into plural areas, and each such area can be assigned or allocated to different entities (e.g., the host 10 or the data storage device 100).

In an embodiment, the host 10 may inquire about whether the data storage device 100 supports space division, and the data storage device 100 may respond to the host 10 about whether space division is supported using the flag. When the data storage device 100 supports space division, the host 10 may transmit, to the data storage device 100, a division request signal for logically dividing a physical space of the storage in the data storage device 100 into plural areas.

In an embodiment, the host 10 may request the data storage device 100 to be divided into a first area directly controllable by the host 10 and a second area controllable by the data storage device 100 itself. When space division is requested, a division ratio of the first area and the second area or of the size of the first and the size of the second area may be set.

The data storage device 100 may collect and store device information on physical location(s) to be set as the first area, and transmit the device information to the host 10 in response to the request of the host 10. In addition, the data storage device 100 may configure system data for physical location(s) to be set as the second area.

Based on the device information on the first area provided from the data storage device 100, the host 10 may directly control or manage the first area by configuring file system data for the first area. A file system may control how data is stored and retrieved. File system data is a type of data or information relevant to the file system. The device information on the first area may include physical configuration information such as a physical address of a block group included in the first area. Based on the physical configuration information on the first area, the host 10 may perform mapping and address translation between a logical address and a physical address and control an internal operation within the first area. The internal operation may include at least one of garbage collection, wear leveling, read reclaim, and error correction functions.

Accordingly, the first area may be directly accessed or managed by the host 10. When a command for accessing the first area is generated by the host 10, the data storage device 100 may control the storage without translation of an address (e.g., a physical address) inputted along with the command, thereby controlling the storage to perform an operation corresponding to the command of the host 10.

The second area may be accessed or managed by the data storage device 100. When a command for accessing the second area is generated by the host 10, the data storage device 100 may translate an address (e.g., a logical address) included in the command of the host 10 into a physical location (e.g., a physical address) of the storage which is accessible by the data storage device 100 and control the storage according to the translated address and the command.

In an embodiment, the first area may be a storage space or a storage region capable of supporting a high-speed operation in correspondence to a request of the host 10. The second area may be used as a storage space or a storage region for stably storing data; however, the present invention is not limited thereto. That is, data to be stored in the first area or the second area may be determined and changed by the host 10 or a user.

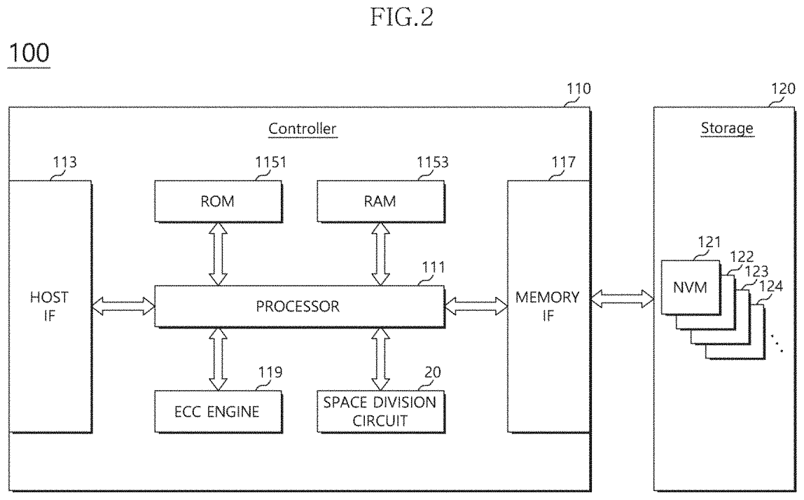

FIG. 2 is a diagram of the data storage device in accordance with an embodiment.

Referring to FIG. 2, the data storage device 100 may include a controller 110 and a storage 120.

The controller 110 may include a processor 111, a host interface (IF) 113, a ROM 1151, a RAM 1153, a memory interface (IF) 117, an error check and correct (ECC) engine 119, and a space division circuit 20.

The storage 120 may include a volatile or nonvolatile memory apparatus. In an embodiment, the storage 120 may be implemented using a memory device selected from various nonvolatile memory devices such as an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM). In an embodiment, the storage 120 may include a plurality of nonvolatile memory devices (NUM) 121 to 124.

Each of the NVMs 121 to 124 may include a plurality of dies Die 0 to Die n, a plurality of chips, or a plurality of packages. Each die, each chip, or each package may include a plurality of memory blocks.

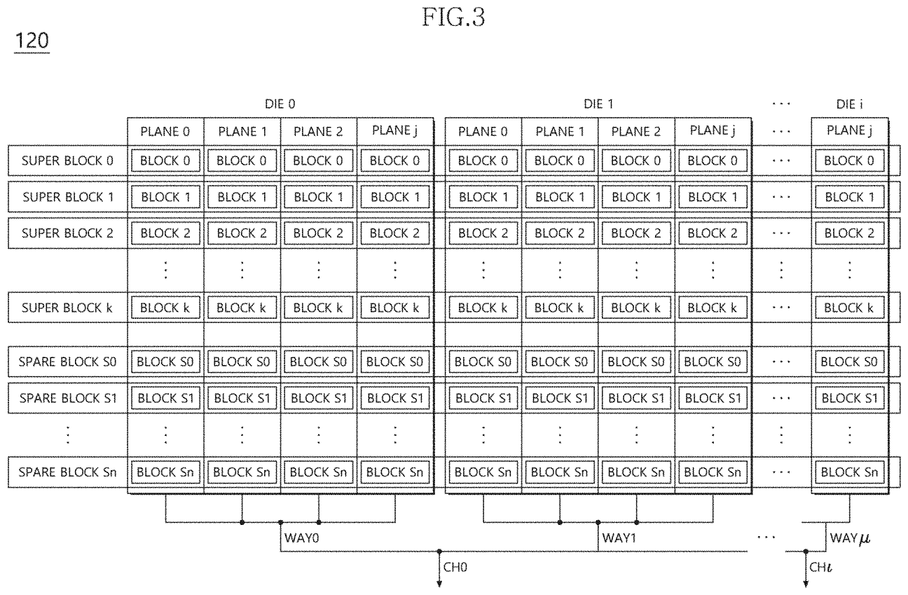

FIG. 3 is a diagram of the storage in accordance with an embodiment.

Referring to FIG. 3, the storage 120 may include a plurality of dies DIE 0 to DIEi. Each of the DIE 0 to DIEi may include a plurality of planes PLANE0 to PLANEj. The controller 110 may configure block groups to form super blocks, i.e., SUPER BLOCK0 to SUPER BLOCKk, by selecting blocks at substantially the same or different positions from the respective planes PLANE0 to PLANEj and grouping the selected blocks. The storage 120 may also include spare blocks, i.e., SPARE BLOCKS0 to SPARE BLOCKSn, not included in the block groups.

The planes (PLANE0 to PLANEj)*i included in the dies DIE 0 to DIEi may input/output data through I channels, i.e., CH0 to CHI, and m ways, i.e., WAY0 to WAYm. That is, FIG. 3 illustrates that one channel is shared by (i/l) ways and one way is shared by j planes.

The controller 110 may group a plurality of memory blocks according to a set criterion and manage the grouped memory blocks as a “block group”. For example, memory blocks included in one block group may be selected through a die interleaving manner at substantially the same time.

Referring back to FIG. 2, the processor 111 may provide various functions for the controller 110 to manage the storage 120. In an embodiment, the processor 111 may allow a write or read command provided from the host 10 to be processed by controlling the host IF 113 and the memory IF 117. The processor 111 may be a microprocessor and/or a central processing unit (CPU) including hardware and software configured to be executed on the hardware.

The processor 111 may be configured to transfer various types of control information for a data read or write operation for the storage 120 to the host IF 113, the RAM 1153, and the memory IF 117. In an embodiment, the processor 111 may operate according to firmware provided for various operations of the data storage device 100.

The host IF 113 may provide an interface between the host 10 and the data storage device 100. The host IF 113 may receive a command and a clock signal from the host 10, store, parse, and schedule the command, and provide the scheduled command to the processor 111, and provide the memory IF 117 with write data provided from the host 10 or provide the host 10 with data provided from the storage 120 through the memory IF 117, under the control of the processor 111.

Particularly, the host IF 113 may provide a physical connection between the host 10 and the data storage device 100. Furthermore, the host IF 113 may provide interfacing with the data storage device 100 in correspondence to a bus format of the host. The bus format of the host 10 may include at least one standard interface protocol, such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small computer system interface (SCSI), a serial attached SCSI (SAS), a peripheral component interconnection (PCI), a PCI express (PCI-E), and/or a universal flash storage (UFS).

The memory IF 117 may transmit data provided from the host IF 113 to the storage 120, or receive data read from the storage 120 and provide the received data to the host IF 113, under the control of the processor 111. To this end, the memory IF 117 may provide a communication channel for signal transmission/reception between the controller 110 and the storage 120.

The ROM 1151 may store program codes for the operation of the controller 110, for example, firmware or software, and store code data and the like used by the program codes.

The RAM 1153 may store data for the operation of the controller 110 or data generated by the controller 110.

The ECC engine 119 may be configured to correct an error that occurs during a data read or write operation for the storage 120.

In an embodiment, the ECC engine 119 may perform an error correction function for data retrieved from both the first area and the second area of the storage 120. In another embodiment, the ECC engine 119 may perform an error correction function for data retrieved from the second area accessed or managed by the controller 110. In such a case, an error correction function for the first area may be performed by the host 10.

The space division circuit 20 may control or manage whether the data storage device 100 supports space division, and use an indicator or an identifier such as a flag to indicate such support. In an embodiment, when the host 10 inquires about whether the space division is supported, the space division circuit 20 may check whether space division is supported and respond to the host 10. In such a case, the device information regarding an entire area of the storage 120 may be provided to the host 10, so that the host 10 may designate physical locations as the first area or the second area. The host 10 can determine which physical locations are assigned to the first area or the second area.

In response to a request of the host 10 for dividing the storage 120 into a plurality of areas, the space division circuit 20 may divide physical locations of the storage 120 into the first area where the host 10 controls or manages file system data and the second area where the controller 110 controls or manages file system data. Furthermore, the space division circuit 20 may generate and store device information on the first area and provide the device information to the host 10 through the host IF 113. Accordingly, based on the received device information, the host 10 may configure the file system data for the first area and directly access or manage the first area. In an embodiment, the device information on the first area may be configuration information on a physical storage space constituting the first area. The space division circuit 20 may also configure file system data for the second area in order to control or manage the second area.

As illustrated in FIG. 3, the storage 120 may include at least one die, each including at least one plane, each including a plurality of memory blocks. Each memory block includes a plurality of pages. Memory blocks having the same offset or different offsets in different dies may be grouped together and managed in units of “block groups”.

The controller 110 and the storage 120 may communicate with at least one die through at least one channel CH. Respective channels may input/output data to/from respective planes included in each die through at least one way WAY.

The configuration information on the first area may include the physical address of the block group included in the first area.

In another aspect, the device information on the first area, that is, the configuration information may include information on a channel (CH) number, a way (WAY) number, a die number, a plane number per die, a memory block number per plane, and a size of a page included in a memory block for a physical space allocated as the first area.

The storage 120 is divided into the first area and the second area by the space division circuit 20. The processor 111 may directly transfer an address, inputted from the host 10 for accessing the first area, to the storage 120 without a separate translation process, but translate an address, inputted from the host 10 for accessing the second area, into a format accessible to the storage 120.

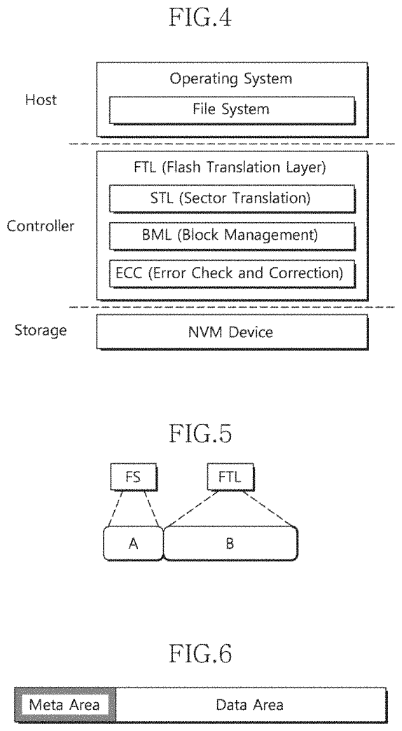

FIG. 4 is a diagram for explaining a management concept of the storage in accordance with an embodiment.

Referring to FIG. 4, an operating system installed in the host 10 may organize or configure information on all files, which includes operating system data, user data, application programs and the like, as a file system for management in order to facilitate their use by the host 10.

The controller 110 of the data storage device 100 operably connected to the host 10 may be implemented with a combination of hardware and software executed on the hardware so as to perform a function of a flash translation layer (FTL) including various functions for managing or controlling the storage 120.

The FTL may include a sector translation layer (STL) for providing functions of garbage collection, address mapping, wear leveling and the like, a block management layer (BML) for checking or managing attributes of a plurality of memory blocks constituting the storage 120, and an error check and correction layer (ECC) for detecting and correcting an error of data retrieved from the storage 120.

When the storage 120 is divided into the first area and the second area, the first area may be directly accessed or managed by the file system of the host 10. The second area may be accessed or managed by a file system configured by the controller 110, for example, the FTL.

Managing the storage 120 may include performing functions of fast data read, write, deletion, and the like. The file system may be configured based on the physical configuration information for the storage 120 so as to read, write or erase a desired file.

For example, the file system is configured to translate the logical address used in the host 10 to the physical address of the storage 120 to manage an internal operation of the garbage collection, wear leveling, error correction, and/or read reclaiming functions.

After the configuration information on the first area is transmitted to the host 10, address translation may be performed based on the file system of the host 10. The host 10 may transmit a translated physical address with a command to the data storage device 100, when accessing data in the first area. Accordingly, the data storage device 100 may omit an operation such as address translation or searching for and loading map data from the storage 120 while the host 10 accesses the first area. Accordingly, time spent on handling or processing a host request by the data storage device 100 having limited resources can be reduced, so that an operation speed of the electronic apparatus 1 can be improved.

When physical locations, which are logically split into the first area and the second area, are determined according to access patterns of the host 10 to the storage 120 and characteristics or attributes of data stored in the storage 120, it is possible to provide a computing environment with higher performance.

FIG. 5 is a diagram for explaining space division of the storage in accordance with an embodiment.

As illustrated in FIG. 5, the storage 120 may be divided into a first area A managed by the file system (FS) of the host 10 and a second area B managed by the FTL of the controller 110.

FIG. 6 is a diagram for explaining a data management structure in accordance with an embodiment.

Data stored in the storage 120 may be managed by the file system (FS) or the FTL as illustrated in FIG. 6 for example.

The data may be divided into a meta area and a data area for management.

The meta area may structurally store a name, a position, a size, a time, deletion or non-deletion and the like, which may be associated with a file recorded in the data area. Because information on all files recorded in the data area may be obtained from the meta area, information on a corresponding file may be recognized only by accessing the meta area unless the file is accessed directly.

In an embodiment, data stored in the first area may be accessed or managed by the file system of the host 10, and data stored in the second area may be accessed or managed by the FTL of the controller 110.

The first area may support a high speed data input/output operation. The second area may operate with higher compatibility with the host 10 than the first area.

The host 10 may configure file system data for the first area as illustrated in FIG. 6 based on the device information provided from the controller 110, and give internal operation authority or control for the first area to the host 10.

The controller 110 may configure file system data for the second area as illustrated in FIG. 6, and operation authority or control for the second area is retained by the data storage device 100.

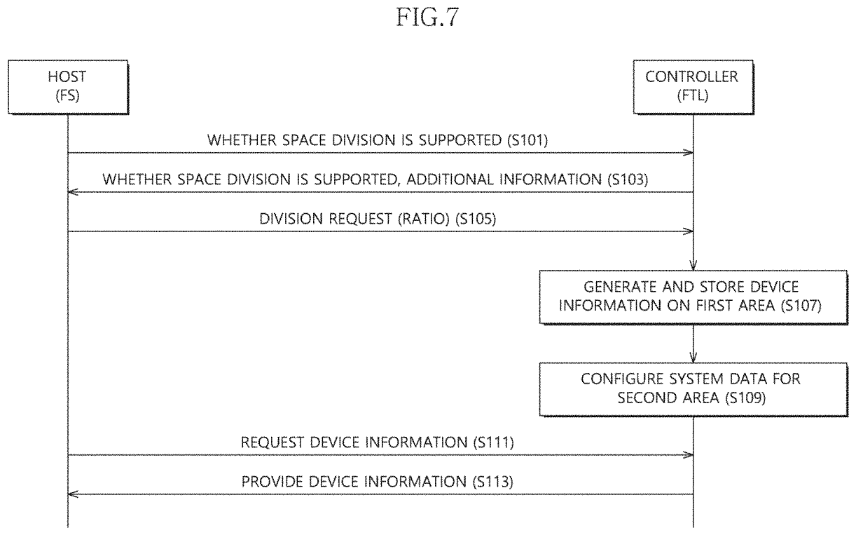

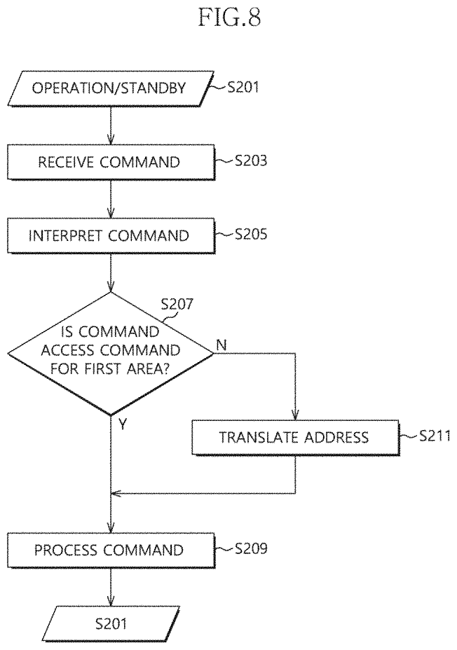

FIG. 7 and FIG. 8 are flowcharts for explaining an operation method of the data storage device in accordance with an embodiment.

FIG. 7 is a flowchart for explaining a space division method in accordance with an embodiment.

The host 10 may, in response to a space division request, inquire about whether the data storage device 100 supports space division (S101). The space division request may be input by a user.

The controller 110 may check whether space division is supported in response to the inquiry of the host 10, and respond to the host 10 about whether space division is supported together with additional information (S103). The additional information may include device information about a nonvolatile storage.

The host 10 may request the controller 110 to perform space division based on a ratio between the first and second areas or a size of the first area and the second area (S105). In response to the host's request, the controller 110 may divide the nonvolatile storage into the first and second areas. The first area is generated, and the controller 110 may recognize or store device information on the first area, such as physical configuration information (S107). In addition, the controller 110 may configure system data for the second area (S109).

In an embodiment, the physical configuration information may include physical addresses of a block group included in the first area.

In another aspect, the device information on the first area, that is, the configuration information, may include information about a channel (CH) number, a way (WAY) number, a die number, a plane number per die, a memory block number per plane, and a size of a page included in a memory block, which can be used for identifying a physical space allocated as the first area.

When the host 10 requests device information on the second area (S111), the controller 110 may transmit the device information, generated in step S107, to the host 10 (S113). Based on the device information, the host 10 may configure file system data based on the device information.

As a consequence, control of the first area may be assumed by the host 10, and control of the second area may be assumed by the controller 110.

FIG. 8 is a flowchart for explaining the operation method of the data storage device after the space division in accordance with an embodiment.

The data storage device is performing an operation or is in a standby state (S201). The controller 110 may receive an access command for accessing the storage 120, which is inputted from the host 10 (S203). The access command of the host 10 may include an address associated with a piece of data to be accessed. In an embodiment, when an access command is directed to the first area, the access command may include a physical address. When an access command is directed to the second area, the access command may include a logical address.

The controller 110 may parse (interpret) the access command transmitted from the host 10 (S205). Based on the device information generated and stored during the space division, the controller 110 may determine whether the access command of the host 10 is for accessing a piece of data stored in the first area or in the second area (S207).

As a result of the determination of step S207, when the access command of the host 10 is for accessing the first area (S207: Y), the controller 110 may not translate the address included in the command provided from the host 10, because the address shows a physical location of the storage 120, and may directly transmit the command to the storage 120, and as a result, an operation corresponding to the command is performed (S209).

On the other hand, when the access command of the host 10 is for the second area (S207: N), the controller 110 may translate a logical address included in the access command provided from the host 10 to a physical address (S211), and may transmit a translated command including the physical address to the storage 120, and as a result, a corresponding operation is performed based on the physical address (S209).

As described above, according to an embodiment, the storage 120 may be divided into the first area that is directly controlled by the host 10 and the second area that is directly controlled by the controller 110.

The host 10 may configure the file system data based on the physical configuration information regarding the first area, generate a command capable of directly controlling or accessing the storage 120, and provide the command to the controller 110. When an access request for a piece of data stored in the first area where the host 10 directly controls, the controller 110 does not translate an address included in the access request provided from the host 10 and transmits the command to the storage 120, thereby making a corresponding operation be performed in the storage 120.

The controller 110 may configure the file system data based on the physical configuration information on the second area. When an access request for a piece of data stored in the second area which the controller 110 controls is generated, the controller 110 translates an address included in the access request provided by the host 10 into a format accessible to the storage 120 (e.g., a physical address), so that a corresponding operation may be performed in the storage 120.

As the first and second areas in the storage 120 are individually managed by the host 10 and the controller 110, respectively, how to use the storage space (e.g., in which area a piece of data is stored) can be determined according to characteristics or attributes of data stored in the storage 120 or an access pattern for the storage 120, so that it is possible to efficiently use the storage 120 and improve operation speed.

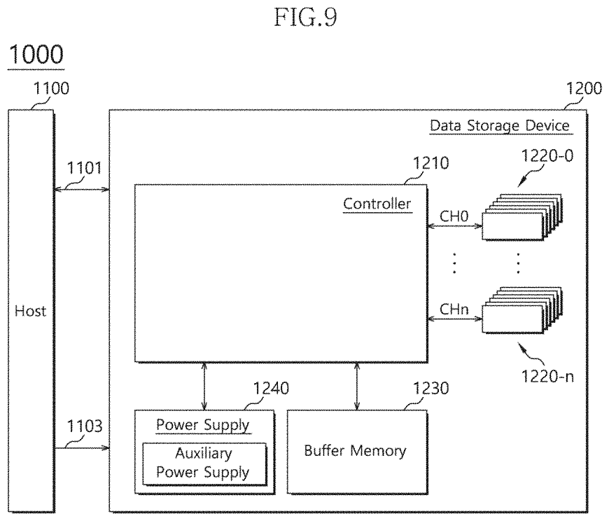

FIG. 9 is a diagram illustrating a data storage system 1000, in accordance with an embodiment.

Referring to FIG. 9, the data storage 1000 may include a host device 1100 and the data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface, a control component, a random access memory used as a working memory, an error correction code (ECC) component, and a memory interface. In an embodiment, the controller 1210 may configured as controller 110 shown in FIGS. 1 and 2.

The host device 1100 may exchange a signal with the data storage device 1200 through the signal connector 1101. The signal may include a command, an address, data, and the like.

The controller 1210 may analyze and process the signal received from the host device 1100. The controller 1210 may control operations of internal function blocks according to firmware or software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CHO to CHn, respectively. One or more nonvolatile memory devices may be coupled to one channel. The nonvolatile memory devices coupled to the same channel may be coupled to the same signal bus and data bus.

The power supply 1240 may provide power inputted through the power connector 1103 to the controller 1210, the nonvolatile memory devices 1220-0 to 1220-n and the buffer memory device 1230 of the data storage device 1200. The power supply 1240 may include an auxiliary power supply. The auxiliary power supply may supply power to allow the data storage device 1200 to be properly terminated when a sudden power interruption occurs. The auxiliary power supply may include bulk-capacity capacitors sufficient to store the needed charge.

The signal connector 1101 may be configured as one or more of various types of connectors depending on an interface scheme between the host device 1100 and the data storage device 1200.

The power connector 1103 may be configured as one or more of various types of connectors depending on a power supply scheme of the host device 1100.

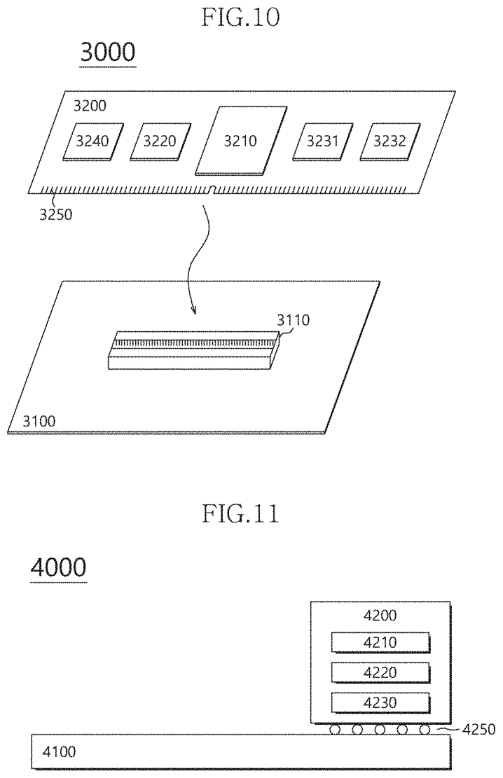

FIG. 10 is a diagram illustrating a data processing system 3000, in accordance with an embodiment. Referring to FIG. 10, the data processing system 3000 may include a host device 3100 and a memory system 3200.

The host device 3100 may be configured in the form of a board, such as a printed circuit board. Although not shown, the host device 3100 may include internal function blocks for performing the function of a host device.

The host device 3100 may include a connection terminal 3110, such as a socket, a slot, or a connector. The memory system 3200 may be mated to the connection terminal 3110.

The memory system 3200 may be configured in the form of a board, such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 shown in FIGS. 1 and 2.

The buffer memory device 3220 may temporarily store data to be stored in the nonvolatile memory devices 3231 and 3232. Further, the buffer memory device 3220 may temporarily store data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250 to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data, and the like, and power may be transferred between the host device 3100 and the memory system 3200. The connection terminal 3250 may be configured as one or more of various types depending on an interface scheme between the host device 3100 and the memory system 3200. The connection terminal 3250 may be disposed on a side of the memory system 3200, as shown.

FIG. 11 is a diagram illustrating a data processing system 4000 in accordance with an embodiment. Referring to FIG. 11, the data processing system 4000 may include a host device 4100 and a memory system 4200.

The host device 4100 may be configured in the form of a board, such as a printed circuit board. Although not shown, the host device 4100 may include internal function blocks for performing the function of a host device.

The memory system 4200 may be configured in the form of a surface-mounted type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 shown in FIGS. 1 and 2.

The buffer memory device 4220 may temporarily store data to be stored in the nonvolatile memory device 4230. Further, the buffer memory device 4220 may temporarily store data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

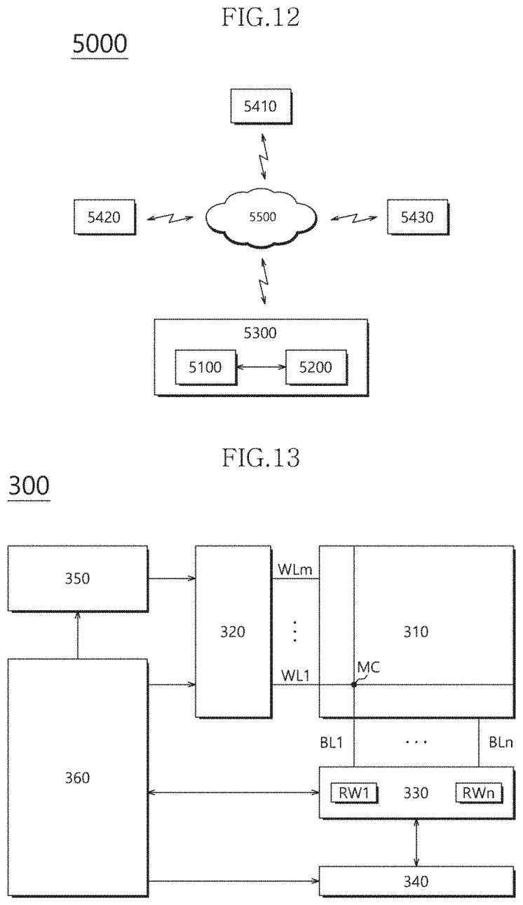

FIG. 12 is a diagram illustrating a network system 5000 including a data storage device, in accordance with an embodiment. Referring to FIG. 12, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may be configured as the memory system 10 shown in FIG. 1, the data storage device 1200 shown in FIG. 9, the memory system 3200 shown in FIG. 10, or the memory system 4200 shown in FIG. 11.

FIG. 13 is a block diagram illustrating a nonvolatile memory device 300 included in a data storage device, such as the data storage device 10, in accordance with an embodiment. Referring to FIG. 13, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array, for example, has a stacked structure extending in a perpendicular direction to the flat surface of a semiconductor substrate. Moreover, the three-dimensional memory array means a structure including NAND strings in which memory cells are stacked perpendicular to the flat surface of a semiconductor substrate.

The structure of the three-dimensional memory array is not limited to the embodiment indicated above. The memory array structure can be formed in a highly integrated manner with horizontal directionality as well as vertical directionality. In an embodiment, in the NAND strings of the three-dimensional memory array memory cells are arranged in both parallel and perpendicular directions with respect to the surface of the semiconductor substrate. The memory cells may be variously spaced to provide different degrees of integration.

The row decoder 320 may be coupled with the memory cell array 310 through the word lines WL1 to WLm. The row decoder 320 may operate according to control of the control logic 360. The row decoder 320 may decode an address provided by an external device (not shown). The row decoder 320 may select and drive the word lines WL1 to WLm, based on a decoding result. For instance, the row decoder 320 may provide a word line voltage, provided by the voltage generator 350, to the word lines WL1 to WLm.

The data read/write block 330 may be coupled with the memory cell array 310 through the bit lines BL1 to BLn. The data read/write block 330 may include read/write circuits RW1 to RWn, respectively, corresponding to the bit lines BL1 to BLn. The data read/write block 330 may operate according to control of the control logic 360. The data read/write block 330 may operate as a write driver or a sense amplifier, according to an operation mode. For example, the data read/write block 330 may operate as a write driver, which stores data provided by the external device in the memory cell array 310 in a write operation. For another example, the data read/write block 330 may operate as a sense amplifier, which reads out data from the memory cell array 310 in a read operation.

The column decoder 340 may operate according to control of the control logic 360. The column decoder 340 may decode an address provided by the external device. The column decoder 340 may couple the read/write circuits RW1 to RWn of the data read/write block 330, respectively corresponding to the bit lines BL1 to BLn, with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided by the external device. For example, the control logic 360 may control operations of the nonvolatile memory device 300 such as read, write, and erase operations of the nonvolatile memory device 300.

While various embodiments have been illustrated and described, it will be understood by those skilled in the art that the disclosed embodiments are examples only. Accordingly, the present invention is not limited by or to the described embodiments. Rather, the present invention encompasses all variations and modifications that fall within the scope of the claims and their equivalents.

What is claimed is:

1. A data storage device comprising:
a storage including a nonvolatile memory apparatus; and
a controller configured to communicate with the storage,
wherein the controller is configured to collect physical configuration information on the storage, divide the storage into a first area and a second area in response to a space division request from a host, and provide the physical configuration information on the first area to the host, thereby giving control of an internal operation for the first area to the host.

2. The data storage device according to claim 1, wherein the storage includes at least one die, each including at least one plane, each including a plurality of memory blocks, each including a plurality of pages, and
the physical configuration information includes a physical address of at least one memory block allocated to the first area.

3. The data storage device according to claim 1, wherein the storage includes at least one die, each including at least one plane, each including a plurality of memory blocks, each including a plurality of pages,
the controller communicates with the at least one die through at least one channel and respective channels input/output data to respective planes in each die through at least one way, and the physical configuration information includes a channel number, a way number, a die number, a plane number per die, a memory block number per plane, and a size of a page in a memory block, for indicating a physical location in the first area.

4. The data storage device according to claim 1, wherein the controller is configured to transfer an address received from the host for accessing the first area to the storage without address translation.

5. The data storage device according to claim 1, wherein the controller is configured to translate an address, received from the host, for accessing the second area into a physical address.

6. The data storage device according to claim 1, wherein the internal operation includes at least one of garbage collection, wear leveling, read reclaim, and error correction functions.

7. The data storage device according to claim 1, wherein the controller is configured to manage an internal operation for the second area.

8. A controller that controls a storage including a nonvolatile memory apparatus, comprising:
a space division circuit configured to collect physical configuration information on the storage, divide the storage into a first area and a second area in response to a space division request from a host, and provide the physical configuration information on the first area to the host, thereby giving control of an internal operation for the first area to the host.

9. The controller according to claim 8, wherein the storage includes at least one die, each including at least one plane, each including a plurality of memory blocks, each including a plurality of pages, and
the space division circuit is configured to generate the physical configuration information including a physical address of at least one memory block allocated to the first area.

10. The controller according to claim 8, wherein the storage includes at least one die, each including at least one plane, each including a plurality of memory blocks, each including a plurality of pages,
the controller communicates with at least one die through at least one channel and respective channels input/output data to respective planes included in each die through at least one way, and
the space division circuit is configured to generate the physical configuration information including a channel number, a way number, a die number, a plane number per die, a memory block number per plane, and a size of a page included in a memory block, for indicating a physical location in the first area.

11. The controller according to claim 8, wherein the controller is configured to transfer, to the storage, an address received from the host that intends to access the first area, without address translation.

12. The controller according to claim 8, wherein the controller is configured to translate an address received from the host that intends to access the second area.

13. The controller according to claim 8, wherein the internal operation includes at least one of garbage collection, wear leveling, read reclaim, and error correction functions.

14. A memory system, comprising:
a non-volatile storage including a plurality of memory blocks; and
a controller configured to divide the plurality of memory blocks into a plurality of areas, each including a respective subset of the plurality of memory blocks, in response to a request received from an external device and grant control of at least one of the plurality of areas to the external device.

15. The memory system according to claim 14, wherein the non-volatile storage includes at least one die, each including at least one plane, each including a plurality of memory blocks, each including a plurality of pages, and
the controller is configured to collect physical configuration information includes a physical address allocated to at least one of the plurality of areas on the non-volatile storage.

16. The memory system according to claim 14, wherein the non-volatile storage includes at least one die, each including at least one plane, each including a plurality of memory blocks, each including a plurality of pages,
the controller communicates with the at least one die through at least one channel and respective channels input/output data to respective planes in each die through at least one way, and
the controller is configured to collect physical configuration information including a channel number, a way number, a die number, a plane number per die, a memory block number per plane, and a size of a page in a memory block, for indicating a physical location to at least one of the plurality of areas.

17. The memory system according to claim 14, wherein the controller is configured to transfer an address received from the external device for accessing to at least one of the plurality of areas to the non-volatile storage without address translation.

18. The memory system according to claim 14, wherein the controller is configured to translate an address, received from the external device, for accessing at least one of the plurality of areas into a physical address.
